(19) United States
(12) Patent Application Publication
(10) Pub. No.: US 2025/0225396 A1
(43) Pub. Date: Jul. 10, 2025

(54) LOSSLESS PARAMETER PRUNING FOR NEURAL NETWORKS

(71) Applicant: GiiLD, Inc., Edina, MN (US)

(72) Inventor: Peter Lin, Worcester, MA (US)

(21) Appl. No.: 18/979,992

(22) Filed: Dec. 13, 2024

Related U.S. Application Data
(60) Provisional application No. 63/619,155, filed on Jan. 9, 2024.

(51) Int. Cl. G06N 3/082

(52) U.S. Cl. CPC G06N 3/082

(57) ABSTRACT

Method and system to prune layer parameters in artificial neural networks in a computing system begins by training a neural network in a supervised manner with labeled datasets divided into training, validation and test subsets. The neural network model includes a plurality of layers each having a plurality of parameters. Pruning reduces the number of parameters, memory used and computational cost in a manner that does not result in degradation in accuracy or loss and does not require retraining.

### CROSS-REFERENCE TO RELATED APPLICATION

This application claims priority to U.S. Provisional Patent Application No. 63/619,155, filed Jan. 9, 2024, the entire disclosure of which is incorporated herein by reference.

### FIELD

This specification relates to pruning layer parameters of neural network models to reduce parameters, memory used and computational cost.

### BACKGROUND

Neural networks are machine learning models with one or more layers of nonlinear units to predict an output for a received input. Neural networks include an input layer, one or more hidden layers, and output layer. The output of each hidden layer is used as an input to the next layer. Each layer of the network generates an output from the received input in accordance with the parameters of the layer.

Training neural network models using supervised and semi-supervised learning begins with obtaining a dataset, pre-processing the data to reduce noise, applying labels to each record, grouping the data to the desired statistical distribution, and segmenting the data into training, validation and test subsets. Obtaining a sufficiently large dataset is time consuming, resource intensive, and expensive. The quality and quantity of the dataset affects the accuracy and loss of the trained model.

State of the art neural network models achieved impressive results by adding more layers and parameters. To achieve this, neural network models run with, for example, hundreds or thousands of layers requires specialized hardware like GPU, ASIC (application specific integrated circuits), or neural processors. However, running large neural network models with millions of parameters on mobile devices like smartphones, tablets, or raspberry pi is inefficient. Iterative magnitude pruning techniques can be used to compress and optimize models for mobile applications, but always require retraining to recover loss in accuracy. Further, in many cases, iterative magnitude pruning does not recover the accuracy after extensive retraining.

### SUMMARY

Aspects of the present disclosure relate to a system implemented as computer programs on one or more computers in one or more locations. The disclosed system determines an architecture for efficient search of prunable parameters in the neural network layer. The results of the search identify the layer parameters that can be set to zero while maintaining accuracy and not increasing the error or loss. The results of the search can be used to modify layer parameters thus reducing the size of the model.

In an aspect, a computer-implemented method, when executed on data processing hardware, causes the data processing hardware to perform operations comprising acquiring at least one digital dataset and training a neural network model using the dataset. The neural network model comprises a plurality of layers and each of the layers comprises a plurality of layer parameters. The method also includes analyzing accuracy and loss of a partially trained version of the neural network model following each of one or more epochs to identify when an epoch corresponds to a prunable pattern. The epochs each represent a complete iteration of the dataset by the neural network model. The method further comprises searching the layer parameters of the partially trained version of the neural network model for the identified epoch corresponding to the prunable pattern to identify one or more prunable parameters contributing to the prunable pattern, modifying the layer parameters of the partially trained neural network model by setting the layer parameters corresponding to the prunable parameters to zero, and applying a modified subset of the layer parameters to the neural network model. The prunable parameters comprise a subset of the layer parameters configurable to zero without impact to accuracy and loss.

In another aspect, an optimized neural network system comprises data processing hardware and a memory storing computer-executable instructions that, when executed by the data processing hardware, configure the optimized neural network system for acquiring at least one digital dataset and training a neural network model using the dataset. The neural network model comprises a plurality of layers and each of the layers comprises a plurality of layer parameters. The neural network system is further configured for storing one or more partially trained versions of the neural network model on a computer-readable storage medium following each of one or more epochs. The epochs each represent a complete iteration of the dataset by the neural network model. The neural network system also generates a detailed report of accuracy and loss for the data set for each partially train version of the neural network model, identifies, based on the accuracy and loss, when an epoch corresponds to a prunable pattern, and searches the layer parameters of the partially trained of the neural network model for the identified epoch corresponding to the prunable pattern to identify prunable parameters configurable to zero without impact to the accuracy and loss. The neural network system is further configured for modifying the layer parameters of the partially trained neural network model by setting the prunable parameters to zero and determining the accuracy and loss of the neural network model after the prunable parameters have been modified.

Other objects and features of the present disclosure will be in part apparent and in part pointed out herein.

### BRIEF DESCRIPTION OF THE DRAWINGS

FIG. 1 is a flow chart diagram of the process for creating a training dataset suitable to train a neural network model according to an embodiment.

FIG. 2 is a flow chart diagram of the runtime process used to train a neural network model according to an embodiment.

FIG. 3 is a flow chart diagram depicting an operation flow for the search process that identifies prunable layer parameters according to an embodiment.

FIG. 4 is a flow chart diagram depicting the process of modifying a model and pruning layer parameters according to an embodiment.

FIG. 5 is a heatmap graph illustrating the changes to the layer parameters between two checkpoint model versions according to an embodiment.

Corresponding reference characters indicate corresponding parts throughout the drawings.

### DETAILED DESCRIPTION

Training neural network models is expensive, requiring millions to billions of records to produce a model capable of accurate prediction on data not present in the training dataset. The size of the trained models has grown in the number of layers and parameters, and have achieved impressive results. However, training neural network models with small datasets less than 1 million records with current methods do not produce reliable models. In many situations, the dataset needed to train a neural network model does not exist and would require years to obtain. Even in situations where the dataset exists, training a neural network model takes years requiring large data centers with thousands of computers. If the training produces a model with sufficient accuracy and loss, the models are often too large or inefficient to run on mobile devices such as laptops, tablets, IoT and smart phones.

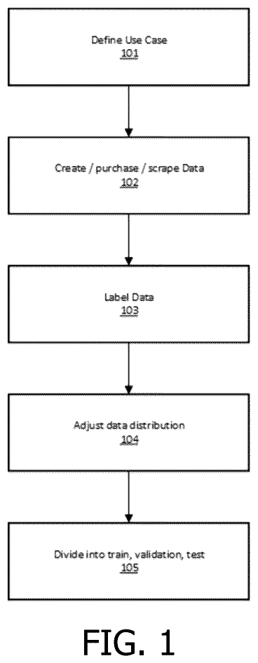

FIG. 1 shows an example process of creating one or more digital datasets suitable for training neural network models. Beginning at 101, defining use case is an iterative process that evolves as the neural network model is trained. Defining a use case involves determining how a user will interact with the model and identifying the particular goal for the model. At 102, creating the dataset may include additional sub processes such as cleansing, deduplication, filtering, down scaling, sampling and/or augmentation to improve the quality of the dataset. At 103, in some embodiments, a human performs labeling of the record. In other embodiments, an automated process performs the labeling. In yet another embodiment, a human in combination with an automated process performs the labeling. Adjusting the dataset distribution at 104 attempts to make a balanced dataset and reduce bias and skew. At 105, dividing the dataset into training, validation, and test subsets can be done manually or randomly by a program.

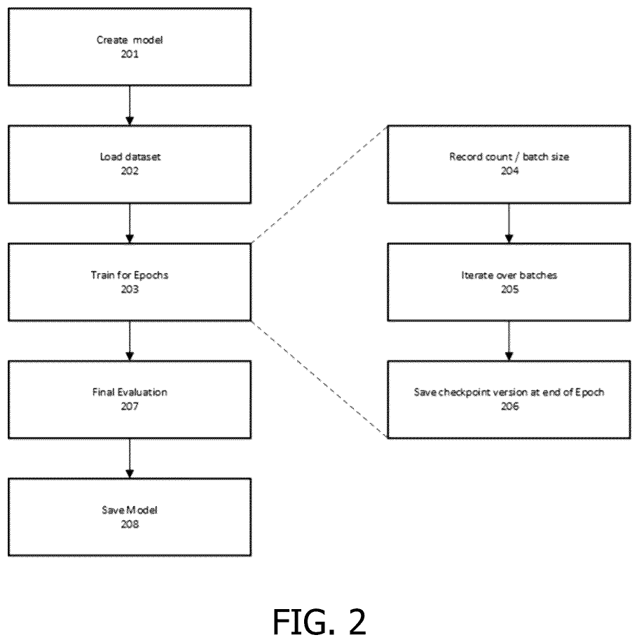

FIG. 2 shows an example process of creating and training a neural network model according to an embodiment of the present disclosure. At 201, the process 200 creates the model which may be one or more models having different numbers of hidden layers with different activation functions and parameters. Loading the dataset at 202 comprises reading the necessary datasets from a storage medium, which may be a local device in some embodiments or a network device in other embodiments. At 203, training for epochs comprises the process of iterating through the entire training and validation datasets. One complete iteration by the neural network model over the training and validation datasets defines one epoch. The process 200 continues with sub-processes 204 to 206 performing operations to iterate over the records in a manner to avoid hardware limitations such as the availability of memory. At 204, a batch calculation sub-process divides the number of records in the given dataset by a batch size. Then at 205, the sub-process iterates over each batch until processing of the full dataset is complete. Proceeding to 206, the sub-process saves a checkpoint version at the end of epoch by writing the layer parameters to a storage medium, which may be a local device or a network device. The number of checkpoint versions at the end of one training session is equal to the number of epochs defined at the start of the training session. By saving a checkpoint version after each iteration, each version can be evaluated for prunable layer parameters and maximizing the effectiveness of the pruning process.

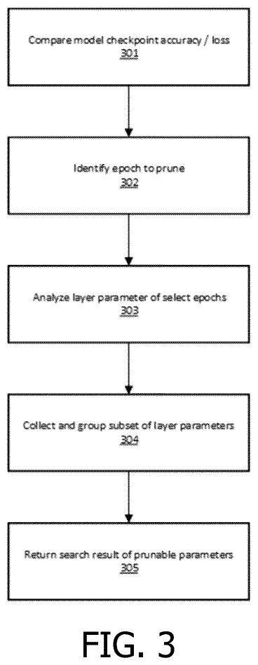

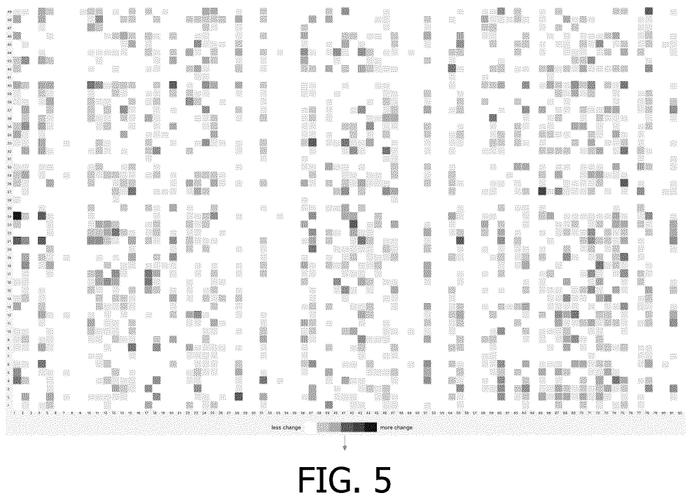

FIG. 3 illustrates an example process of identifying prunable layer parameters that can be pruned without unwanted side-effects or negative impact on accuracy or loss on the test dataset according to an embodiment. Beginning at 301, the process compares checkpoint accuracy and loss creating a detailed report of the positive and negative predictions for the training and validation datasets. The report groups the prediction results by record, which can be used for visualization or search operation. FIG. 5 illustrates an example of creating a positive and negative prediction report according to an embodiment. Next at 302, identifying epochs to prune reduces the search space and makes the operation more efficient. In some embodiments, identifying epochs to prune comprises a procedural process of identifying epochs indicating prunable patterns. In other embodiments, a human reviews the report to identify epochs indicating prunable patterns. In yet another embodiment, a human evaluates the report in conjunction with a procedural process to identify epochs indicating prunable patterns. At 303, the process 300 analyzes layer parameters to identify the prunable parameters by comparing the parameter changes between checkpoints. In one or more embodiments, the prunable parameters include parameters that remain unchanged between checkpoints. At 304, the process collects and groups a subset of layer parameters to sorts the results. Then at 305, the process returns a search result of prunable parameter as the final output of the search operation.

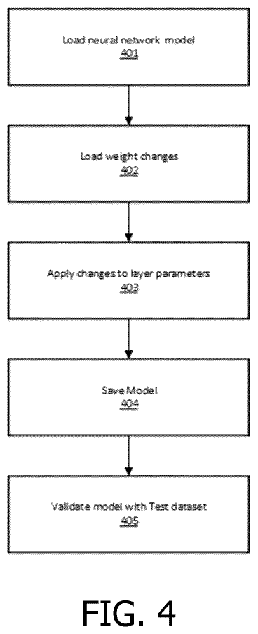

FIG. 4 illustrates an example process 400 of loading a model, applying changes to layer parameters and saving the optimized model according to an embodiment. Beginning at 401, the process 400 loads a neural network model which can be any checkpoint version of the model. The model is read from the storage device and loaded into memory. Next at 402, the process 400 reads the load weight changes from FIG. 3 into memory. Then at 403, the changes are applied by iterating over the list of changes and modifying the layer parameter. In one embodiment, applying changes includes setting the value of all prunable parameters to zero. Thus, setting the prunable parameters to zero reduces the size of the model and increases efficiency. Saving the model 405 comprises writing the updated model to the storage device. Then at 405, validating the model with test dataset verifies the changes did not negatively impact the accuracy or loss.

FIG. 5 illustrates one possible embodiment of visualizing the changes to layer parameters between one or more versions of the model checkpoints in the form of a heatmap. The benefit of visualizing the changes between checkpoint versions is it provides additional data to explore and understand the layer parameters.

By identifying the layer parameters that are prunable without a negative impact on test accuracy and loss, it reduces the time and processing to optimize models. In other words, lossless pruning negates the need to retrain the model to recover accuracy and loss due to undesirable side-effects. In many cases, lossy pruning never recovers the original accuracy. Aspects of the present disclosure overcome this limitation of lossy pruning.

By identifying lossless prunable layer parameters, models can be optimized and deployed in an embodiment to mobile devices faster and with lower power consumption. In other words, lossless pruning layer parameters enables deploying models to mobile devices with less processing power and reduces the power draw on batteries.

By identifying lossless prunable layer parameters, the pruned model uses less memory. In other words, pruned models use less memory and improve the responsiveness of the model.

Commonly assigned U.S. Non-Provisional patent application Ser. No. 18/644,670, filed Apr. 24, 2024, the entire disclosure of which is incorporated by reference, discloses a system implemented as computer programs on one or more computers in one or more locations that determines an architecture for efficient search of anomalous patterns in neural network layer parameters. The results of the search identify the layer parameters contributing to anomalous patterns and undesirable behavior. The results of an anomaly pattern search can then be used to modify layer parameters to improve prediction accuracy and loss on training, validation, and test datasets

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers, and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A computer-implemented method when executed on data processing hardware causes the data processing hardware to perform operations comprising:
acquiring at least one digital dataset;
training a neural network model using the dataset, the neural network model comprising a plurality of layers, each of the layers comprising a plurality of layer parameters;
analyzing accuracy and loss of a partially trained version of the neural network model following each of one or more epochs to identify when an epoch corresponds to a prunable pattern, the epochs each representing a complete iteration of the dataset by the neural network model;
searching the layer parameters of the partially trained version of the neural network model for the identified epoch corresponding to the prunable pattern to identify one or more prunable parameters contributing to the prunable pattern, wherein the prunable parameters comprise a subset of the layer parameters configurable to zero without impact to accuracy and loss;
modifying the layer parameters of the partially trained neural network model by setting the layer parameters corresponding to the prunable parameters to zero; and
applying the modified subset of the layer parameters to the neural network model.

2. The computer-implemented method of claim 1, wherein the epoch corresponding to the prunable pattern is a subset of one or more partially trained versions of the neural network model.

3. The computer-implemented method of claim 1, wherein searching the layer parameters of the partially trained version of the neural network model comprises performing a search operation to compare the layer parameters between partially trained versions of the neural network model and identify the prunable parameters contributing to the prunable pattern.

4. The computer-implemented method of claim 3, wherein the search operation returns the prunable parameters for one or more of the layers contributing to the prunable pattern.

5. The computer-implemented method of claim 4, wherein applying the modified subset of the layer parameters to the neural network model comprises loading the partially trained version of the neural network model with the prunable parameters returned by the search operation to generate a modified version of the neural network model.

6. The computer-implemented method of claim 5, further comprising generating a detailed report of accuracy and loss for the dataset for the modified version of the neural network model.

7. The computer-implemented method of claim 1, further comprising generating a detailed report of accuracy and loss for the dataset for each partially trained version of the neural network model.

8. The computer-implemented method of claim 7, wherein generating the detailed report includes positive and negative prediction details for each record in the dataset for all partially trained versions of the neural network model.

9. The computer-implemented method of claim 7, wherein analyzing accuracy and loss of a partially trained version of the neural network model to identify when an epoch corresponds to a prunable pattern is based on the detailed report.

10. The computer-implemented method of claim 1, further comprising determining the accuracy and loss of the neural network model after modifying the layer parameters by setting the prunable parameters to zero.

11. An optimized neural network system comprising:
data processing hardware; and
a memory storing computer-executable instructions that, when executed by the data processing hardware, configure the optimized neural network system for:
acquiring at least one digital dataset;
training a neural network model using the dataset, the neural network model comprising a plurality of layers, each of the layers comprising a plurality of layer parameters;
storing one or more partially trained versions of the neural network model on a computer-readable storage medium following each of one or more epochs, the epochs each representing a complete iteration of the dataset by the neural network model;
generating a detailed report of accuracy and loss for the data set for each partially train version of the neural network model;
identifying, based on the accuracy and loss, when an epoch corresponds to a prunable pattern;
searching the layer parameters of the partially trained of the neural network model for the identified epoch corresponding to the prunable pattern to identify prunable parameters configurable to zero without impact to the accuracy and loss;
modifying the layer parameters of the partially trained neural network model by setting the prunable parameters to zero; and
determining the accuracy and loss of the neural network model after the prunable parameters have been modified.

12. The system of claim 11, wherein the computer-readable storage medium for saving the partially trained version of the neural network model comprises a local device or a network device.

13. The system of claim 11, wherein the epoch corresponding to the prunable pattern is a subset of one or more partially trained versions of the neural network model.

14. The system of claim 11, wherein searching the layer parameters of the partially trained version of the neural network model comprises performing a search operation to compare the layer parameters between partially trained versions of the neural network model and identify the prunable parameters contributing to the prunable pattern.

15. The system of claim 14, wherein the search operation returns the prunable parameters for one or more of the layers contributing to the prunable pattern.

16. The system of claim 11, wherein the instructions in memory further comprise loading the partially trained version of the neural network model with the prunable parameters returned by the search operation to generate a modified version of the neural network model.

17. The system of claim 16, wherein the instructions in memory further comprise saving the modified version of the neural network model on the computer-readable storage medium.

18. The system of claim 12, wherein generating the detailed report includes positive and negative prediction details for each record in the dataset for all partially trained versions of the neural network model.

19. The system of claim 11, wherein the instructions in memory further comprise generating a record generalization score representing a prediction accuracy for each test record of the dataset.

20. The system of claim 11, wherein the data processing hardware comprises a mobile phone.
